(19) United States
(12) Patent Application Publication
(10) Pub. No.: US 2014/0106099 A1
(43) Pub. Date: Apr. 17, 2014

(54) ROLL-UP FURNITURE LEG FLOOR PROTECTOR

(71) Applicant: Pierre Desmarais, Cantley (CA)

(72) Inventor: Pierre Desmarais, Cantley (CA)

(21) Appl. No.: 14/044,666

(22) Filed: Oct. 2, 2013

Related U.S. Application Data
(63) Continuation-in-part of application No. 13/336,957, filed on Dec. 23, 2011, now abandoned.
Application No. 13/336,957 is a continuation of application No. 12/082,054, filed on Apr. 8, 2008, now abandoned.

(30) Foreign Application Priority Data
Apr. 20, 2007 (CA) 2585597

(51) Int. Cl. A47B 91/00; B29C 45/00

(52) U.S. Cl. CPC A47B 91/002; B29C 45/0005
USPC 428/36.1; 264/257

(57) ABSTRACT

There is provided a process for making a furniture leg floor protector having a plastic body and a floor-contacting pad, by placing a soft pad into a mold cavity whereby an upper pad layer is located at a position corresponding to a bottom wall of the protector, introducing molten plastic into the mold to form the protector body and infiltrating interstices within an upper layer of the felt pad with plastic while leaving the lower layer of the pad essentially free of plastic thereby integrating the pad with the body. The upper, plastic-infiltrated layer is in the range of 0.5 to 2 mm in thickness. The invention further relates to a protector having a plastic body and a floor-contacting pad integrated with the body, in which an upper layer of the pad has interstices filled with plastic and a lower layer is essentially free of plastic.

### CROSS-REFERENCE TO RELATED APPLICATIONS

This application is a Continuation in Part of U.S. patent application Ser. No. 13/336,957 filed Dec. 23, 2011, which is a Continuation of U.S. patent application Ser. No. 12/082,054 filed Aug. 4, 2008 (now abandoned), and claims priority from Canadian Patent Application No. 2,585,597 filed in Canada on Apr. 20, 2007. The entire contents of the above applications are incorporated herein by reference.

### FIELD OF THE INVENTION

This invention relates to furniture leg floor protectors and a process for making them and is applicable to furniture leg floor protectors for use with moveable furniture that normally contacts the floor such as chairs, tables, stools and sofa.

### BACKGROUND

Furniture leg floor protectors have commonly been in use for many years. These are used to avoid damage to for example hardwood floors when a chair or table is moved. They also reduce noise in the classroom where children tend to move their desks and chairs around often making an irritating noise.

Most present day floor protectors consist of a semi-rigid plastic body which includes an upper sleeve with circular side walls that forms a socket for receiving the furniture leg such as a chair or table. After the fabrication process, a soft pad is fastened to the bottom of the body, typically by adhesive. The pad may be constructed of felt or other soft material. The pad can also be formed of a deformable resilient material to stabilize the object to give a support surface.

Attaching the pad onto the leg protector body typically represents an extra step in the manufacturing process which is sometimes be done by hand and thus is labor intensive. Moreover, over time the adhesives tend to wear out or become detached and the pad must be replaced. Another problem with some semi-rigid elastomer protectors is that the upper sleeve, after significant use, becomes enlarged and the protector tends to fall off the chair or table leg.

Attempts to increase friction and long life of the upper sleeve of a floor protector have been partially successful. For example, in U.S. Publication No. 2004/0123421 A1, a corrugated sleeve having folds therein to increase friction has been utilized. It would appear however that the complexity of the molding process could make this option uneconomical.

### SUMMARY

An object of this invention is to provide an improved protector for engaging to a furniture leg and a process for fabricating same.

One aspect of the present invention relates to a one-step process for fabricating a furniture leg floor protector comprising a plastic body for securing a furniture leg and an integrated floor pad, the pad having an upper layer comprising felt and a lower layer. The process comprises the steps of:

a) providing a mold having a cavity for molding the body of a floor protector,
b) placing the pad into the mold cavity whereby the upper layer of the pad is located at a position corresponding to a bottom wall of the protector body and the lower layer of the pad is opposed to the bottom wall position, namely facing away from the bottom wall of the protector body,
c) introducing molten plastic into the mold whereby the molten plastic infiltrates interstices within the upper layer while leaving the lower layer of the pad essentially free of plastic, wherein the upper layer is in the range of 0.5 to 2 mm in thickness. The molten plastic may be introduced by conventional injection molding or other molding techniques. This step integrates the pad into the structure of the protector body by the plastic being infiltrated into interstices between fibers of the upper layer of the pad, with the lower layer of the pad being essentially free of plastic to allow this layer to remain soft for contacting the floor, and
d) removing the finished protector from the mold.

The body may have a lip extending downwardly from the bottom wall and surrounding an upper portion the pad, wherein the step of injecting plastic infiltrates a portion of the pad with plastic where the pad contacts the lip.

According to another aspect the invention relates to a furniture leg floor protector comprising a plastic body having a socket defined by a sidewall for receiving a foot portion of the furniture leg and an integral bottom wall. The protector includes a pad having an upper layer thereof comprising felt and a lower layer. The upper layer is in the range of 0.5 to 2 mm in thickness and is integrated with the bottom wall of the body by plastic material infiltrated within interstices in the upper layer. A lower layer of the pad is essentially free of plastic.

According to other aspects, the upper layer may be within narrower ranges of 0.7-1.7 in thickness, 0.7-1.4 mm or about 1.0 mm in thickness.

The felt pad may comprise wool or a blend of wool and one or more of polyester, nylon, rayon, polytetrafluoroethylene or cotton, or an entirely non-wool felt material.

The plastic material may be substantially transparent when hardened.

The present inventor has found that if a felt pad, such as 100% wool felt, is placed in the bottom of the mold, when the injection-molding process takes place the molten plastic introduced into the mold infiltrates interstices within the upper fibrous surface of the felt pad. Once the plastic has set, cooled and been removed from the mold, the felt pad forms an integral part of the floor protector and cannot be separated therefrom without damage. That is to say, it is more or less permanently affixed.

A surprising discovery of the inventor is that a protector may be fabricated with a felt pad integrally molded with the protector body by infiltrating interstices located within a relatively thin upper layer of the pad with the plastic of the lower wall of the protector. This integration permits the pad to essentially permanently adhere to the protector body and resist relatively high shear forces, with the thinness of the layer of integration permitting a relatively thick lower layer of the pad to be free of plastic in the felt interstices. This allows the thick lower layer to remain soft to be long-wearing and highly functional at protecting a floor surface.

The sidewall may comprise a semi-rigid lower sidewall portion sized to receive a foot portion of the furniture leg and having the integral bottom wall, and a flexible upper sidewall portion elastically stretchable to allow an end of the foot portion to be passed through the upper sidewall portion and into the lower sidewall portion, the upper sidewall frictionally elastically engaging the furniture leg above the foot portion in use.

The upper sidewall may be thinner than the lower side wall, the upper side wall being sufficiently stretchable to roll outwards or fold outwards over the lower side wall and unroll or unfold up the leg during installation to frictionally adhere to the leg, constantly exerting an inward force towards the leg and thus preventing the floor protector from falling off the furniture leg. Moreover, in the folded down or rolled down sleeve position, the protector is small and easier to ship and handle, as it takes up a smaller volume.

In certain embodiments of the present invention, the furniture leg protector comprises a one piece plastic elastomer body with a felt pad, for example 100% wool, embedded in the bottom during the molding process. The protector can take many shapes, providing that there is sufficient friction between the upper sleeve/circular side wall and the chair leg. The felt pad can be rounded or have an aperture therein or simply one piece with planar top and bottom surfaces. After molding, the felt pad may protrude from the elastomer body in order to have proper contact with the floor. The stretchable upper sleeve is generally constructed to be much thinner than the lower circular wall, which must be more rigid to support the bottom of the chair leg. The thickness of the sleeve can diminish from the bottom to the top, i.e. the remote end which provides access for the chair leg during installation. It may also be tapered or in some cases cone-shaped. In other embodiments, the sleeve upper side wall can have a concave outer side and a convex inner side. It is of course possible to also have an upper sleeve or upper side wall of equal thickness in the form of a cylinder.

### DEFINITIONS

The following terms shall have the meanings described below, unless the context clearly dictates otherwise:

“Leg” or “furniture leg” shall mean any floor-contacting part of an article of furniture, musical instrument such as a piano or other moveable object that can be placed on a floor, and in respect of which a lower portion may be inserted into a floor protector to protect against damage to the floor. A “leg” includes, for example, a table, chair, sofa or stool leg, a post for a bed or piano, or a workstand leg.

“Wool or wool blend” shall mean fibres that are at least in part derived from animal wool such as sheep wool; a wool blend may include synthetic or other non-wool fibres blended into the material.

“Felt” refers to a non-woven textile produced by matting, condensing or pressing fibres together, or a material that has similar physical properties to conventional felt. Felt may be made from natural materials such as wool or a wool blend or plant-derived materials, or synthetic materials, or any combination of the above.

“Plastic” refers to a Synthetic or semi-synthetic organic solid material that can be molded using conventional processes, and which during the molding process can be melted or otherwise liquified into a relatively low viscosity liquid capable of infiltrating interstices in a felt material. Plastics include but are not limited to thermo-plastic elastomeric materials.

“Interstices” refers to spaces or gaps between or within fibers within felt material. Interstices will vary in dimensions and are a function of the density of the material. Interstices include any space within the material in which molten plastic may intrude during a molding process.

“Molding” and related terms refers to techniques and processes by which an article is formed by introducing a molten or liquid material into a mold, following by solidifying and removal from the mold. As discussed herein, various molding techniques are known to the art and may be used for the present invention.

“Molten” refers to a liquid state of a material that subsequently solidifies into a non-liquid state, and includes material that liquefies when heated or material which may exist in a liquid state at room temperature or other working temperature and which can solidify by a chemical reaction when molded.

Directional references are used herein purely for convenience of description and are not intended to limit the scope of the invention. It will be understood that the objects described herein may be rotated into any orientation. Directional references include such terms as “upper”, “lower” “vertical”, “horizontal” and the like.

### BRIEF DESCRIPTION OF THE DRAWINGS

Preferred embodiments of the invention will be described in detail by way of example only in conjunction with the following drawings, wherein:

FIG. 1A is a transverse cross section and FIG. 1B is a top view of a prior art floor protector;

FIG. 2 is a longitudinal section of a prior art floor protector;

FIG. 3 is a longitudinal cross section of a preferred embodiment of the present invention;

FIG. 4 is a longitudinal cross section of the embodiment shown in FIG. 3, wherein the upper circular side walls have been rolled down for transport and pre-installation;

FIG. 5 is a longitudinal cross section of the embodiment shown in FIG. 3, wherein the upper sleeve or side walls have been folded down for transport and pre-installation;

FIGS. 6, 6A and 6B are a longitudinal cross section, top view, and bottom view, respectively, of another embodiment of the present invention;

FIGS. 7, 7A and 7B are respectively a longitudinal cross section, top view and bottom view of another embodiment of the present invention;

FIGS. 8, 8A and 8B are respectively a longitudinal cross section, top view and bottom view of a cylindrical embodiment of the present invention;

FIGS. 9, 9A and 9B are respectively, a longitudinal section, top view, and bottom view of another embodiment of the present invention;

FIGS. 10, 10A and 10B are respectively a longitudinal cross section, a top view, and bottom view of the embodiment shown in FIG. 3;

FIGS. 11, 11A and 11B are respectively a longitudinal cross section, a top view, and bottom view of another embodiment of the invention;

FIGS. 12, 12A and 12B show an embodiment of the invention showing a curved felt bottom pad;

FIGS. 13, 13A and 13B show a circular bottom pad, having planar top and bottom surfaces; and

FIGS. 14, 14A and 14B show a bottom felt pad having a circular aperture in the center thereof.

FIGS. 15A and 15B are cross-sectional views of a mold configured for molding a protector according to the invention, wherein FIG. 15A shows a mold half prior to filling with plastic and FIG. 15B shows a finished protector according to the invention prior to removal from the mold.

### DETAILED DESCRIPTION

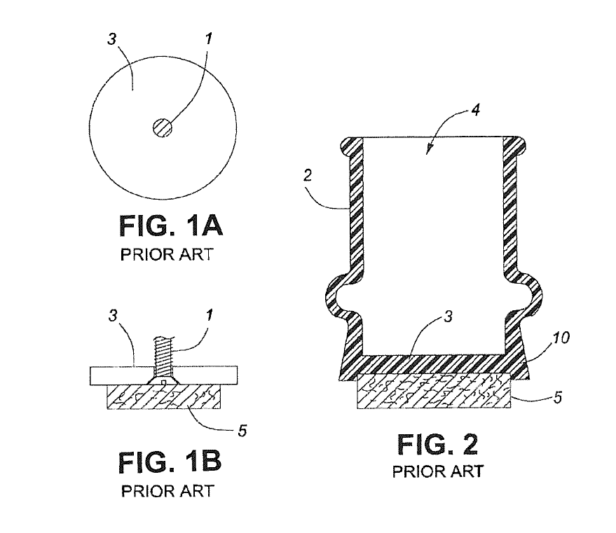

FIG. 1 shows a prior art furniture leg floor protector device 1. It has a bottom wall (3). The configuration is generally cylindrical and it is basically composed of hard plastic material. A felt pad (5) is attached by double face tape to the bottom of bottom wall (3) and a screw adheres the protector to a furniture leg bottom portion in the normal course of construction.

FIG. 2 shows another prior art floor protector. It is comprised of a furniture leg floor protector having a semi-rigid circular body (2). A bottom wall (3) is integrally molded as a part of the circular body (2). A circumferential lip, descending from body (2), is marked (10). A pad 5 is placed in the recess below bottom wall (3), and secured with pressure sensitive hot-melt adhesive.

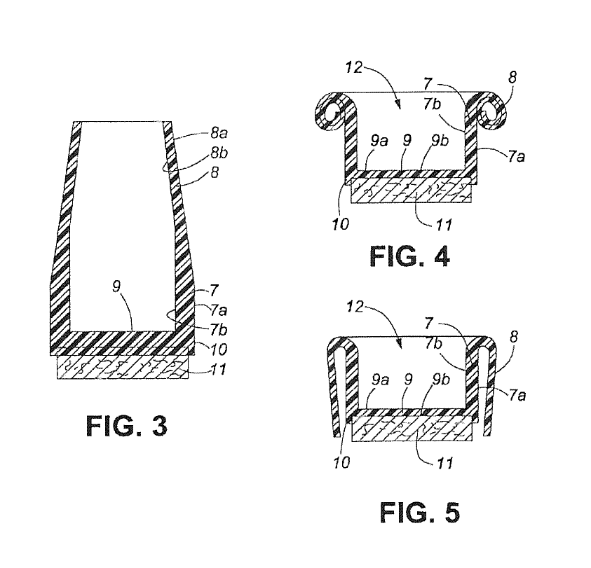

FIG. 3 shows a longitudinal cross section of a floor protector 100 according to the present invention. Protector 100 comprises a plastic body no which is integrated with a felt pad it, described below, for contacting the floor. Body 110 comprises an upwardly-opening socket 20 for receiving a furniture leg. Socket 20 is defined by upper circular, flexible, stretchable wall (8) and a thinner lower circular wall (7). Wall (8) has an outside surface (8a) and an inside surface (8b). The lower portion of lower circular wall (7) also includes a circumferential lip (10) which defines a downwardly opening socket 22. This is configured to seat a felt pad (11) which may be disc shaped, as shown in FIG. 3, or it may comprise a different configuration such as the examples describes below. Lower circular wall (7) is semi-rigid and has an outer side (7a) and an interior side (7b). It is integrally connected to bottom wall 9 and circumferential lip (10). Bottom wall 9 defines a partition between sockets 20 and 22 and thus serves as both the floor of socket 20 and the ceiling of socket 22. The advantage of the upper circular wall (8) is that it becomes, with lesser thickness, increasingly flexible and elastic and adapted with greater friction to adhere to a bottom of a chair leg or table leg. The thicker lower portions (7), (9), (10), provide some rigidity to the floor protector.

Felt pad 11 comprises a pure wool felt or alternatively a wool blend such as wool fibres blended with fibres of polyester, nylon, rayon, polytetrafluoroethylene (e.g., Teflon′) or cotton or a combination thereof. A suitable wool blend is 50/50 wool/polyester. Other felts may be used, such as polyester and/or PTFE, as well as others. The density of the felt can range from 0.05 to 0.3 g/cm3. With at least some types of felt, a density significantly lower than this may result in too much plastic becoming infused in the felt and any significantly higher density can result in too little material entering into an infiltrating into the felt thereby making the bond superficial. As well, the felt must be sufficient soft to prevent damage to the flooring.

It has been found that a high density wool or wool blend felt provides a suitable level of infiltration of the molten plastic within an upper layer of the pad, as discussed below. Benefits to providing this type of felt as a uniform material for the pad include: a) durability with regards to wear on the floor, b) integration with the plastic of bottom wall 9, the pad becomes securely adhered to bottom wall 9 and very difficult to delaminate from the plastic. Conversely, a low density felt can either delaminate too easily when submitted to the shear forces of the chair leg sliding over the floor or will be infused with too much plastic material leaving very little or no felt protruding, and c) a high density felt offers a better seal (gasket effect) during the high pressure injection of plastic to avoid unsightly plastic material seepage around the felt.

The thickness of the felt pad may be selected based on the expected use of the device. For typical use as a protector for a chair or table, the felt pad may have an overall thickness of about ⅛″ to ¼″

The plastic material of body no is relatively flexible, stretchable and resilient to permit the sleeve to conform to and grip a range of furniture leg shapes. The material should also maintain its gripping force for a long time which means once stretched the material must be sufficiently resilient come back to its initial size as much as possible. An elongation set of less than 5% is preferred to offer the long term gripping force required. Certain types of TPU (thermoplastic polyurethane) offer a good combination of elongation, resiliency and stretchability, for example the Estane™ family of TPU by Lubrizol. Silicone rubber is also a suitable material. Another relevant factor is the tackiness of the material. A TPU material that is relatively tacky adds to the gripping capability of the resulting floor protector. A TPU of durometer Shore 60 to 70 A provides a suitable degree of flexibility and stretchability.

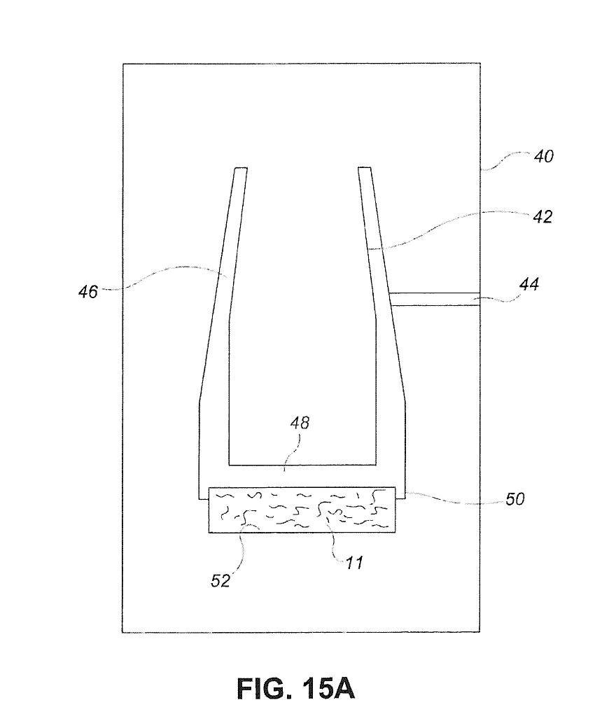

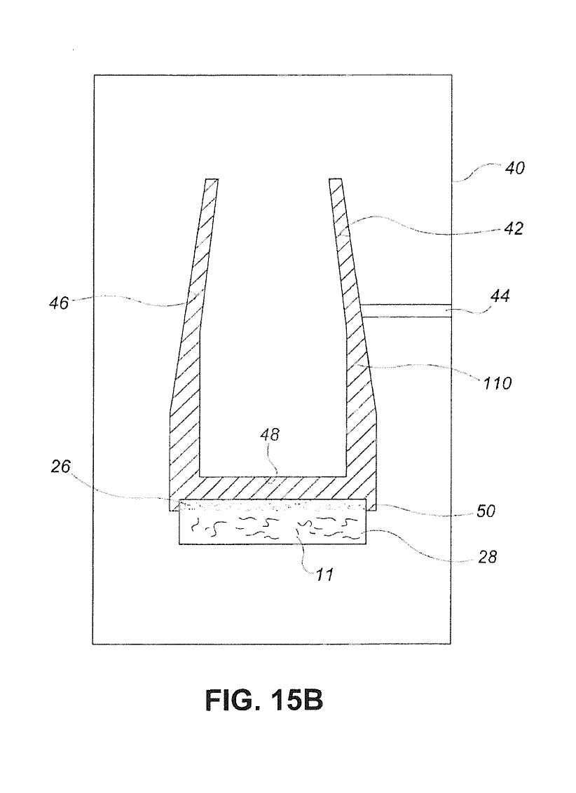

During the molding process while the plastic is in a liquid and free-flowing state, the plastic material infiltrates interstices of pad 11 within an upper layer 26, thereby integrating pad 11 with body no. Lower layer 28 is essentially free of plastic within the felt interstices. The thickness of upper layer 26 is selected to provide an essentially permanent attachment of pad to body no. Upper layer 26 can be relatively thin while still providing sufficient adhesion. For example, upper layer 26 may be within the range of 0.5-2 mm, or more narrowly 0.7-1.7 mm or 0.7-1.4 mm in thickness. In the present embodiment, upper layer 26 is about 1 mm in thickness. Lower layer 28 may be any desired thickness depending on factors such as the pressure expected to be borne, the amount of expected wear (eg. chair leg protectors are expected to receive more wear than more stationary objects such as tables) and other factors. In the present example, lower layer 28 is about 4 mm thick for an overall pad thickness (upper plus lower layer) of about 5 mm. The upper and lower layers of pad 11 are shown in FIG. 15b.

The upper and lower layers 26 and 28 need not be physically distinct but instead may merge into one another, wherein pad 11 comprises an essentially uniform felt material prior to infiltration by plastic. Upper and lower layers 26 and 28 are thus defined only by the presence or essential absence of infiltrated plastic within the felt pad, and wherein the respective layers are not sharply defined.

FIG. 4 shows a rolled storage position longitudinal cross section of the embodiment shown in FIG. 2. The upper circular side wall or sleeve (8) being thin, is able to be rolled outwardly and downwardly to abut lower side wall (7). Lower side wall (7) has an inside wall (7b) and an outside wall (7a). Similarly, the bottom wall (9), which is integrally joined to lower circular side wall (7) during molding, by infiltration of molten plasticized thermoplastic elastomer material into interstices between fibers at the surface of the felt pad placed in the mold, has an upper side (9a) and a lower side (9b). The felt pad (11) is adapted to fit upwardly under the bottom side (9b) of the bottom side wall. FIG. 4 shows a longitudinal conventional shipping and handling configuration of the present invention.

FIG. 5 shows another shipping and handling configuration of an embodiment of the invention shown in FIG. 3. Thinner flexible and stretchable side wall (8) has been folded outwards and downwards to be adjacent to lower circular side wall (7). Felt pad (11) remains attached after the molding process, thus the embodiment of the present invention shown in FIG. 5 or FIG. 4 can be shipped in a relatively compact state to save volume requirements.

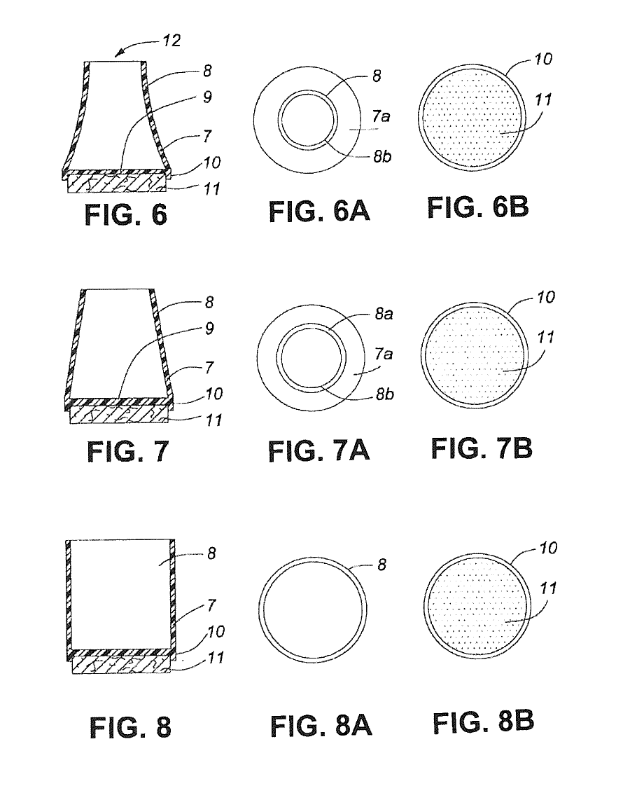

FIGS. 6, 6A and 6B show a variant of the present invention. Upper circular side wall (8) is concave outwardly and adjoins lower side wall (7). This concave wall increases flexibility and fits more furniture leg shapes. The curved conical shape increases grip at the top of the protector.

FIG. 7 shows another variant of the present invention wherein the semi-rigid circular lower side wall (7) merges almost imperceptibly into the upper side wall (8). The two walls apparently having the same thickness. The circumference of the top portion of flexible, stretchable side wall (8) at its top is significantly less than the circumference of circular side wall (7). A felt (11) has been appropriately applied to the product.

In FIG. 8, the cylindrical side walls are basically vertical with no tapering. Upper side walls (8) are perfectly in line with lower side walls (7). This particular embodiment of the invention, with a cylindrical shape, improves production speed, but is not as strong.

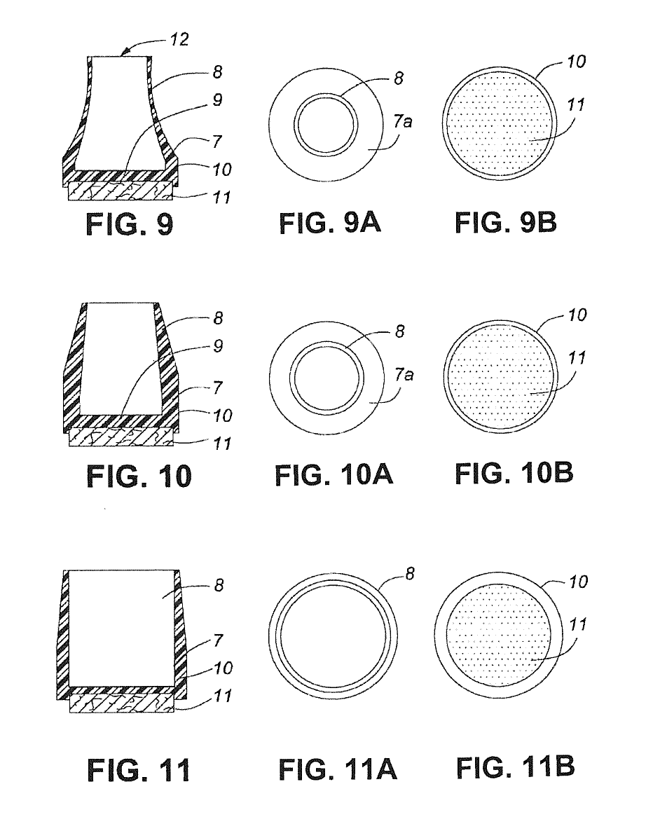

FIGS. 9, 9A and 9B show a variant of the present invention. There is a tapered side wall (8) commencing at the top of the lower circular side wall (7) and ending at the upper end of the side wall (8). This tapered wall increases stability at the bottom of the protector, and its curved conical shape, which is concave on the outside of the side wall (8) and convex on the inside of the side wall (8), increases grip at the opening of the protector.

FIG. 10 shows another variant of lower circular side wall (7) and upper circular side wall (8) which is tapered inwardly and upwardly and the side wall (8) is thinner at the top than at the bottom. The usual lower circumferential lip to surrounds the felt pad (11), which is situated under the bottom wall (9).

FIGS. 11, 11A and 11B, showing a longitudinal cross section, a top view and a bottom view, respectively, show a substantially cylindrical upper and lower sleeve. However, there is a tapered wall to increase stability at the bottom of the protector. The cylindrical shape improves production speed, because it's easier to remove from the mold. The upper circular side wall (8) can, for the purposes of shipping and handling, be either folded downwardly or rolled downwardly, as its flexibility and stretchability is significantly greater than that of lower circular side wall (7).

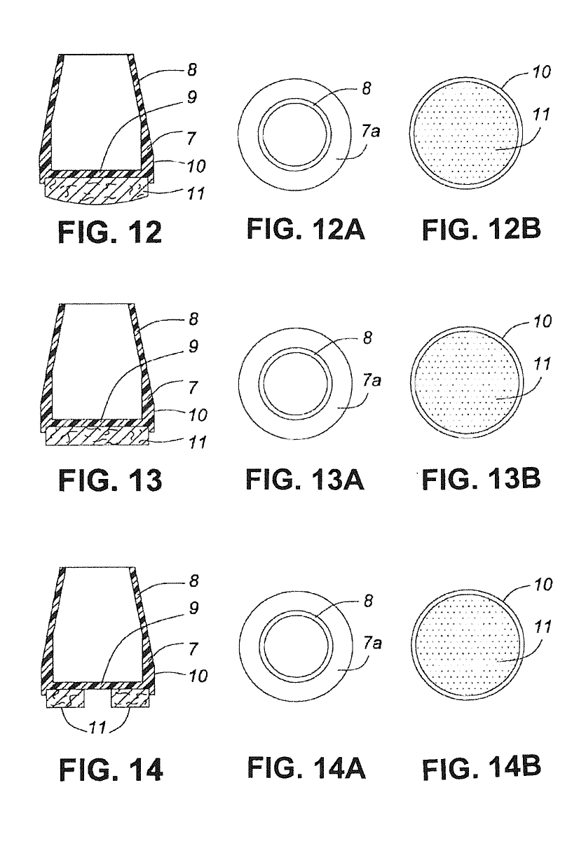

FIGS. 12, 13 and 14, show longitudinal cross sections of varying embodiments of the invention, along with their counterparts 12A, 13A and 14A top views, respectively, and 12B, 13B and 14B bottom views, respectively.

In FIG. 12, felt pad (11) has a bottom side which is outwardly convex.

In FIG. 13, the felt pad (11) has a planar upper surface and a planar lower surface and is circular in form.

In FIG. 14 a felt pad is shown having an aperture (13). It is believed that injection through the bottom hole could increase clarity of the product and visual appeal. In terms of production, a hole or aperture (13) in felt pad (11) will decrease cost and not particularly sacrifice stability.

FIGS. 15A and B illustrate a mold 40 for use in the process of fabricating protector 100. Mold 40 comprises a cavity 42 which communicates with an external source of molten plastic (not shown) through bore 44. FIGS. 15A and 15B depict a mold half—it will be understood that the complete mold 40 comprises an essentially identical opposing half (not shown) that mates therewith to form the complete mold. Cavity 42 comprises an upper portion 46 that corresponds to socket 20 of protector 100, a floor portion 48 that corresponds to bottom wall 9 and a lip portion 50 that corresponds to lip 10 of protector 100. Cavity 42 further comprises a base portion 52 for receiving a felt pad 11. Base portion 52 is recessed from lip portion 50 to define a shoulder 54.

The initial step in molding protector 100 consists of positioning felt pad 11 within base portion 52 within one half of mold 40. Felt pad 11 is configured to snugly fit within base 52 such that plastic introduced into cavity 42 is substantially prevented from coating the sides of felt pad 11 except where pad 11 contacts bottom wall 9 and the inside surface of lip 10; at these locations, pad 11 effectively forms the mold surface for these portions of body 110. The respective mold halves are then secured together and molten plastic is introduced through bore 42 through conventional injection molding techniques. It will be understood that other molding processes known to the art may be used, with suitable modifications to mold 40. The injected plastic is introduced under conditions of temperature and pressure that generates a predetermined depth of infiltration of plastic into interstices within pad 11. Conditions that affect the depth of infiltration within felt pad 11 are known to the art and can be manipulated according to known principles, optionally with routine experimentation. Relevant factors include the physical properties of the plastic, the viscosity of the plastic when melted at a selected temperature and its rate of hardening during cooling, the speed of cooling (the latter two properties determining the duration during which infiltration may occur), injection pressure, average/maximum interstice size (a function of felt density) and other properties of the felt, depth of infiltration required and other factors known to the art.

Injection of plastic into cavity 42 in one step thus forms body 110 and integrates pad 11 with body 110 by integrating upper layer 26 of pad 11 with bottom wall 9. As well, lip 10 is formed and surrounds an upper portion of pad 11, with the lower edge of lip 10 being defined by shoulder 54 in cavity 42. The inside surface of lip 10 contacts pad 11 and integrates therewith by infiltration of plastic from this surface into a thin layer of pad 11, thereby providing additional support for pad 11 when subjected to shear. Effectively, upper layer 26 can thus be socket-shaped. The infiltration of plastic within upper layer 26 forms a rigid layer that merges with bottom wall 9 to effectively provide the entire protector as a single monolithic unit that is very difficult to separate under normal conditions of use.

Particular benefits may derive from the manufacture of the integrally molded furniture leg protector, wherein the injection molding takes place on and around the felt pad and the molten plasticized thermoplastic elastomer material infiltrates the interstices between fibers of the upper fibrous surface of the felt pad so that when the body has been removed and cooled the infiltrated material secures the pad permanently to the bottom wall without separate adhesive. It is a novel and effective way to ensure fixation of the felt pad to the thermoplastic elastomer body to ensure long life of the product.

The scope of the invention should not be limited by the preferred embodiments set forth in the examples, but should be given the broadest interpretation consistent with the description as a whole. The claims are not to be limited to the preferred or exemplified embodiments of the invention.

1. A process for making a furniture leg floor protector comprising a plastic body and a floor-contacting pad integrated with the body, the body comprising a socket to receive a foot portion of said furniture leg and a bottom wall, said pad having an upper layer comprising felt and a lower layer, the process comprising: providing a mold having a cavity for molding said body of said floor protector, placing said pad into the mold cavity whereby the upper pad layer is located at a position corresponding to said bottom wall and the lower pad layer is opposed to said position, introducing molten plastic into said mold whereby said molten plastic forms said protector body and infiltrates interstices within said upper layer while leaving the lower layer of the pad essentially free of plastic thereby integrating said pad with the bottom wall of said body, wherein the upper layer is in the range of 0.5 to 2 mm in thickness, and removing said protector from the mold.

2. The process of claim 1 wherein said upper layer is selected from: 0.7 to 1.7 mm in thickness, 0.7 to 1.4 mm in thickness, and about 1.0 mm in thickness.

3. The process of claim 7 wherein said body further comprises a lip extending from said bottom wall and surrounding an upper portion the pad, wherein the step of injecting plastic infiltrates a portion of said pad with plastic where the pad contacts the lip.

4. The process of claim 1 wherein at least said upper layer comprises wool or wool blend felt.

5. The process of claim 1 wherein said pad comprises an essentially uniform felt material prior to molding.

6. The process of claim 1 wherein said plastic comprises TPU or Elastane.

7. The process of claim 1 wherein said molding comprises injection molding.

8. A process for making a furniture leg floor protector comprising a plastic body and a floor-contacting pad integrated with said body, the body comprising a socket to receive a foot portion of said furniture leg and a bottom wall, the pad having an upper layer comprising wool or wool blend felt and a lower layer, the process comprising: providing a mold having a cavity for injection molding said body of said floor protector, placing said pad into the mold cavity whereby the upper pad layer is located at a position corresponding to said bottom wall and the lower pad layer is opposed to said position, injecting molten plastic into said mold whereby said molten plastic forms said protector body and infiltrates interstices within said upper layer while leaving the lower layer of the essentially pad free of plastic, thereby integrating said pad with the bottom wall of said body, wherein the upper layer is in the range of 0.5 to 2 mm in thickness, and removing said protector from the mold.

9. The process of claim 8 wherein said upper layer is selected from: 0.7 to 1.7 mm in thickness, 0.7 to 1.4 mm in thickness, and about 1.0 mm in thickness.

10. The process of claim 8 wherein said body further comprises a lip extending from said bottom wall and surrounding an upper portion the pad, wherein the step of injecting plastic infiltrates a portion of said pad with plastic where the pad contacts the lip.

11. The process of claim 8 wherein said pad comprises an essentially uniform felt material prior to molding.

12. The process of claim 8 wherein said plastic comprises TPU or Elastane.

13. A furniture leg floor protector comprising a plastic body having a socket defined by a sidewall for receiving a foot portion of said furniture leg and an integral bottom wall, the protector further comprising a pad having an upper layer thereof comprising felt and a lower layer wherein the upper layer is in the range of 0.5 to 2.0 mm in thickness, said upper layer being integrated with said bottom wall of said body by said plastic infiltrated within interstices within the upper layer and the lower layer being essentially free of plastic.

14. The protector of claim 13 wherein said upper layer is selected from: 0.7 to 1.7 mm in thickness, 0.7 to 1.4 mm in thickness, and about 1.0 mm in thickness.

15. The protector of claim 13 wherein said body further comprises a lip extending from said bottom wall and surrounding an upper portion the pad, wherein the step of injecting plastic infiltrates a portion of said pad with plastic where the pad contacts the lip.

16. The protector of claim 13 wherein said pad comprises an essentially uniform felt material prior to infiltration of the upper layer with plastic.

17. The protector of claim 13 wherein said plastic comprises TPU or Elastane.

18. The protector of claim 13 wherein said felt pad comprises wool or a blend of wool and one or more of polyester, nylon, rayon, polytetrafluoroethylene or cotton.

19. The protector of claim 13 wherein said sidewall has a wall thickness which is either essentially uniform or has a decreasing thickness from a lowermost position to an uppermost position.

20. The protector of claim 13 wherein the configuration of said felt pad is selected from one of a disk shaped, a convex lower outer surface and a toroidal (ring) shaped.

21. The protector of claim 13 further comprising a circumferential lip extending from said lower sidewall portion to surround said felt pad, wherein said pad is infiltrated with plastic within a portion of said pad where the pad contacts the lip.

22. The protector of claim 13 wherein at least a portion of the sidewall is stretchable to such an extent that the upper sidewall portion can be rolled or folded outwards to overlie the lower sidewall portion.

23. The protector of claim 13 wherein said pad has a density of 0.05-0.3 gm/cm3.

24. The process of claim 1 wherein said pad has a density of 0.05-0.3 gm/cm3.
